(19) United States
(12) Patent Application Publication
(10) Pub. No.: US 2008/0292094 A1
(43) Pub. Date: Nov. 27, 2008

(54) Business telephone system voicemail circuit card with integrated audio output

(76) Inventors: Greg Coleson, Decatur, GA (US); Brent Kandetzki, Decatur, GA (US)

Correspondence Address: MCNAIR LAW FIRM, P.A., P.O. BOX 10827, GREENVILLE, SC, 29603-0827, US

(21) Appl. No.: 11/804,867

(22) Filed: May 21, 2007

(51) Int. Cl. H04M 11/00

(52) U.S. Cl. 379/433.09; 379/101.01

(57) ABSTRACT

A voicemail circuit card for use in a business telephone system is provided that includes internal memory and integrated audio outputs built into the card. Prerecorded audio files can be stored in the memory and output directly from the card to the business telephone system through the integrated audio outputs.

### BACKGROUND OF THE INVENTION

The invention relates to a voicemail (VM) circuit card used in a business telephone system and, more particularly, to a VM circuit card that contains integrated audio outputs for music playback. These integrated audio outputs eliminate the need for a separate, external audio player device, normally used to input music-on-hold (MOH) and background music (BGM) into a business telephone system, which increases the physical space required in the system cabinet or rack.

Telephone and data systems have changed a great deal since the inception of the plain old telephone system (POTS). Modern business telephone systems utilize many of the vast improvements in computer technology to process more calls, connect more telephones, and provide more services, such as VM, BGM and MOH. In fact, modern business telephone systems are increasingly modeled after larger-scale, rack-type computer systems to allow for improved setup, interchangeability, and maintenance. A typical business phone system will, therefore, comprise a rack-type housing that contains multiple interchangeable circuit cards. Because these circuit cards are housed within individual slots inside the racks of the business telephone system, they are also commonly referred to as “in-skin” cards. Each of those circuit cards will in turn generally provide a different service or feature within the overall business telephone system.

For example, a typical business phone system will include at least four circuit cards inserted into individual slots within a rack-type housing of a base unit. Among those four cards will likely be one or more of: (i) a central processing unit (CPU) card that essentially controls the various interactions among all components of a private branch exchange (PBX), key system unit (KSU), or hybrid-type business telephone system, (ii) a service gateway or central office (CO) input card to connect an available telephone service provider, (iii) a digital station card to connect the various telephones used in the office, and (iv) a VM card to provide an outgoing, saved VM message and to store VM messages left for office telephones. Such systems also commonly use Internet-protocol (IP) telephony cards to connect and distribute the telephone service to an internal business telephone network using IP.

The rack-type business telephone system is both an advantage and limitation over the prior art. To wit, rack-type systems allow more functionality to be packed into a smaller space within a cabinet. But such functionality is limited to that which can be provided in a circuit card that fits into one of the available slots in the cabinet. All other system components must fit elsewhere and often end up resting outside of the cabinet due to lack of space. One such example is an audio player device traditionally used to input MOH, BGM, company announcements, company advertisements, and the like into the system.

Traditional business telephone systems generally utilize separate audio player devices, such as AM/FM receivers, cassette tape players, CD players, and the like to play live or prerecorded audio files in the telephone system. The same devices are often used to playback prerecorded audio files to the company intercom. In each case, these devices are housed external to the business telephone system, require manual changes to the physical device to change the audio selection, and are not generally capable of allowing users to easily erase, store, and reconfigure the audio output.

U.S. Pat. No. 7,076,052 to Yoshimura discloses a telephone terminal device that provides playback of MOH and BGM. The device does not, however, provide any mechanism for connection to a rack-type business telephone system. Instead the device provides playback only in individual phones by downloading audio files to those individual phones. U.S. Pat. App. Pub. No. 2004/0066915 discloses an audio message recording and playback system that contains a voice module-memory unit or card-for playback of audio messages. But the device does not provide for storage and playback of prerecorded messages for services, such as MOH or BGM. Similarly, U.S. Pat. No. 5,539,818 discloses a telephone system containing a prerecorded voice message unit or card that is removable and transportable to an equivalent telephone system. Although this system provides some mechanism for storing a prerecorded audio file, it neither provides for integration into a rack-type business telephone system nor provides storage for playback of other types of audio files, such as MOH and BGM. Moreover, none of these systems provide a VM circuit card for use in a business telephone system having integrated audio outputs which can be input into the system.

What is needed is a business telephone system VM card with built-in, integrated audio outputs, capable of providing playback of prerecorded audio files, such as MOH and BGM, announcements, etc. Properly configured, such a card could store both prerecorded audio files and VM messages left by callers, preferably using one or more integrated memory means.

Accordingly, an object of the present invention is to provide a business telephone system VM circuit card which stores prerecorded audio files that may be output directly to one or more integrated audio outputs of the card.

Another object of the present invention is to provide a memory integrated into or resident upon the card that is capable of storing both prerecorded audio files and VM messages left by callers. Such memory could be a single or multiple flash memory resident upon the card.

Another object of the present invention is to provide the card in a manner that avoids the need for an additional audio playback device to play prerecorded audio files, such as MOH and BGM.

Another object of the present invention is to provide a card that is user-programmable so that the audio files stored on a flash memory are easily updated, either by physical connection or network connection.

Other objects and benefits of the present invention will become apparent from the detailed description when taken in conjunction with the drawings provided.

### SUMMARY OF THE INVENTION

The foregoing objects have been achieved in the present invention, whereby the present invention overcomes the above identified and other deficiencies in conventional business telephone systems, by providing integrated audio outputs built into the VM card. The apparatus and method provide for a business telephone system that requires less physical space within its rack cabinet. The apparatus and method further provide for greater flexibility in use of prerecorded audio in the system.

The objectives are accomplished by providing a voicemail (VM) circuit card with integrated audio outputs for installation in a business telephone system. The card includes a processor for controlling the flow of electronic data within the card and a computer-readable memory for storing audio files. Generally the audio files include prerecorded audio files, such as MOH or BGM, and/or later recorded VM messages. Integrated audio outputs built into the VM card provide direct input of the audio files into the business telephone system. Advantageously, the memory may be removable from the VM card to change or add music. Audio playback in a business telephone system is provided without the need for a separate audio or electronic playback device.

The card may also include one or more of the following: a serial port to provide an integration link, programming connection, electronic pager connection, or troubleshooting connection to the card; a VM circuit activity indicator to indicate usage of one or more VM circuits; a power status indicator to indicate usage of the card; a flash memory status indicator to indicate usage of the flash memory; and a 10BaseT port to connect the card to another electronic device using Internet-protocol for communication.

The invention also comprises a method of providing audio playback output of MOH and background music directly from a VM circuit card in a business telephone system in the following steps. First, a printed circuit card designed for use as a VM card in a business telephone system is provided. Next, one or more prerecorded audio files are stored on a memory that is built into the card. Finally, audio playback of the audio files is provided directly from the card to the business telephone system. This method provides the advantage of less needed physical space within the business telephone system cabinet by avoiding the need for a separate audio playback device in the system.

The method may also comprise the steps of providing a serial port on the card to provide one of an integration link, programming connection, electronic pager connection, and troubleshooting connection to the card. The programming connection can be used to change the stored audio music or other sound filters in the memory.

### BRIEF DESCRIPTION OF THE DRAWINGS

FIG. 1 is an elevation view illustrating the voicemail circuit card installed with the base unit of a business telephone system with the integrated audio outputs connected directly to the audio inputs of a central processing unit according to an illustrated embodiment of the invention.

FIG. 2 is a perspective view of a voicemail circuit card for a business telephone system, according to an illustrated embodiment of the invention.

FIG. 3 is a perspective view of the voicemail circuit card of FIG. 1 with a removable music memory card, according to an illustrated embodiment of the invention.

FIG. 4 is a flow chart illustrating a method for playing background music, or “music on hold” using a voicemail circuit card with a flash memory and two integrated audio outputs, according to an illustrated embodiment of the invention.

### DETAILED DESCRIPTION OF A PREFERRED EMBODIMENT

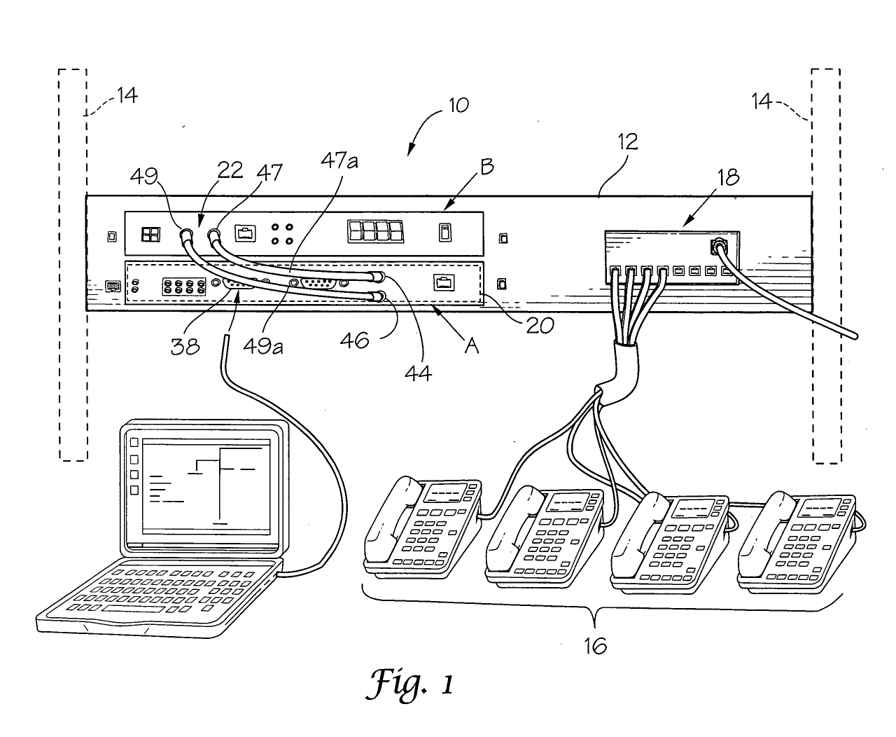

The invention is perhaps better understood with reference to the drawings which provide illustrations of a preferred embodiment according to the invention. FIG. 1 is an illustration of a business telephone system, designated generally as 10, having, among other generally required components, a base unit 12 mounted on a rack 14. A plurality of phone desk sets 16 are connected to a digital interface 18 of the base unit, a voicemail circuit (VM) card, designated generally as A, is designed to fit into a circuit card slot 20 within base unit 12. A central processing unit (CPU) card 22 is carried in another card slot of base unit 12.

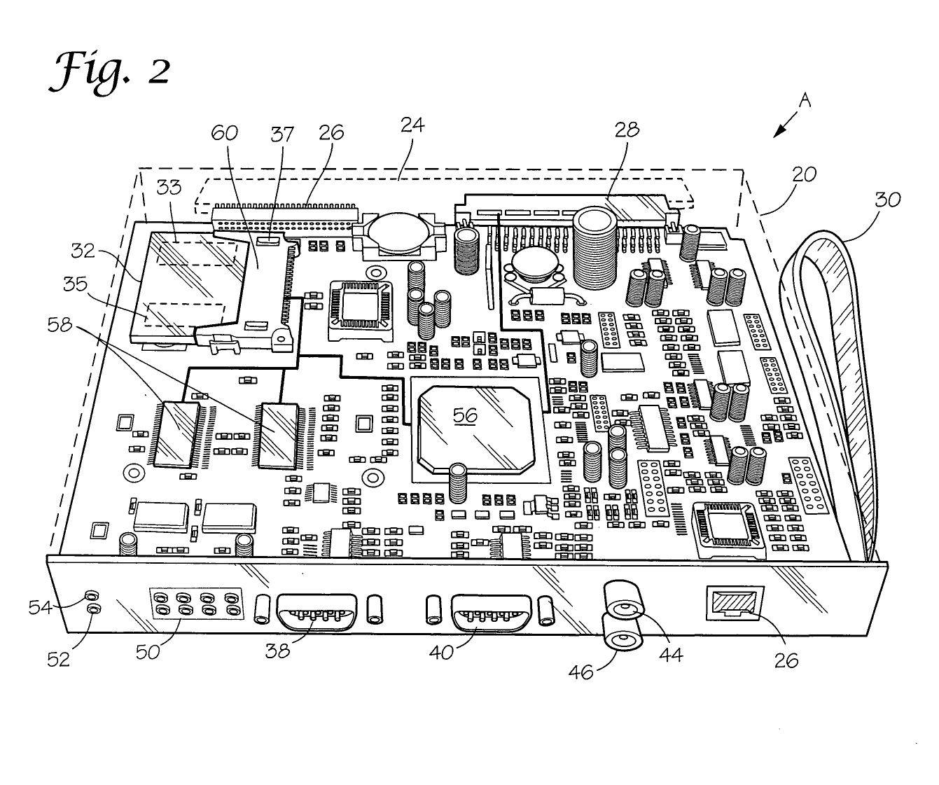

As can best be seen in FIG. 2, when the VM card is installed into card slot 20, the card connector 28 connects with back-plane connector 24 to the system using the electrical contacts disposed therein. An IDE connector 26 connects the card memory, described below, to the telephone system, or to another memory adapter. A strap 30 may be produced to pull the card out of the slot.

The VM card includes a computer-readable memory 32 which may be any suitable memory such as a flash memory card or a hard drive. The memory preferably stores at least two types of audio files (a), prerecorded “music on hold” (MOH) and “background music” (BGM) files 33, and (b) later recorded VM message files 35. The prerecorded MOH and BGM files are stored in memory 32 so that a user may easily erase, save, or reconfigure new audio files at a later date. As illustrated, memory 32 includes a flash memory card which is removably received in a memory card slot 60 on the VM card. Using suitable software designed to communicate with VM circuit card A, a user may connect to flash memory 32 to manipulate prerecorded audio files and playback parameters for each, or the card may be removed for exchange or re-recording.

As can best be seen in FIG. 2, a second flash memory card (not shown) may be carried on the VM card for additional memory storage. In this case, the second memory card is piggy-backed on top of memory card 32 and fitted therewith by means of notches 37 on card holder 60, and complementing elements carried by the second card. The pins of the second card connect with IDE connector 26. Alternately, a hard drive may be piggy-backed and connected to IDE connector 26.

Communication and programming with VM card A may occur in a variety of ways, either directly or through a network. For example, a user may connect to the VM card through the business telephone system network in base unit 12 using computer hardware and software. Computer hardware may connect using 10Base-T connector 36, or serial ports 38 and 40. In this way, card A is easily programmable in a variety of ways so as to provide greater flexibility in the setup and operation of both the VM system and the business telephone system.

Most importantly, VM circuit card A includes audio outputs built into and integrated with the VM circuit card so as to eliminate the need for a separate external audio player or input device. As illustrated, there are two audio outputs 44 and 46. Once audio files 33 are stored on memory card 32 of the VM card, the music may be output through integrated audio outputs 44 and 46. Configured as shown, BGM is played as needed from audio output 44 and MOH is played as needed from audio output 46. The VM card eliminates the need for external audio players and devices by storing MOH and BGM audio files in memory 32 and playing those audio files back through audio outputs 44 and 46. While the audio outputs and inputs are shown as including conventional jacks in the illustrated embodiment, the outputs and inputs may be wired internally without external jacks and cables. For example, BGM audio files may be output through back-plane card connector 28 using a dial a page code of the business system and play the audio through the paging system. Multiple dial code page zones may be used to play music in each of them. The term output and input are meant to include, among other things, external jacks and cables, and internal connections without the same.

As can best be seen in FIG. 1, BGM output 44 is connected directly to an audio input 47 on CPU card 22 and MOH output 46 is connected directly to an audio input 49 of the CPU card by cables 47a and 49a, respectively. In this manner, the audio music files are played through the business telephone system in the usual way.

Serial ports 38 and 46 are also useful in other ways. As shown in FIG. 1, serial port 38 may be configured as a console port to allow a technician to program and troubleshoot card A using a computer. Serial port 40 is easily configurable as an integration link to the business telephone system, for example, as a station message detail information (SMDI) link. Serials ports 38 and 40 are easily configurable to perform any or all of the above-listed functions.

Card 100 further contains a variety of indicator lights. VM circuit activity indicator lights 50 illuminate to indicate operation of one or more of the 8 VM circuits available for use in card A. When a VM circuit is setup for operation on card A, that VM circuit is assigned a circuit number from 1 to 8. When operation of any of those VM circuits is subsequently detected, the corresponding VM circuit activity indicator light 50 will illuminate. Card A also contains flash memory status indicator 52 to indicate usage of flash memory 32. And finally, card A contains power status indicator 54 to indicate power is connected to the VM card.

VM circuit card A includes a processor 56 for controlling the flow of electronic data and two ROM memory chips 58, or other computer-readable memory, for storing the firmware necessary to operate card A. When card A is properly connected and running within a business telephone system, processor 56 references the firmware settings stored in ROM 58 to make all decisions, take all actions, and perform all necessary tasks to operate card A, including receiving voicemails in each VM circuit, storing voicemails in memory 32, playing back voicemails to a user, playing back MOH and BGM stored in memory 32, and the like.

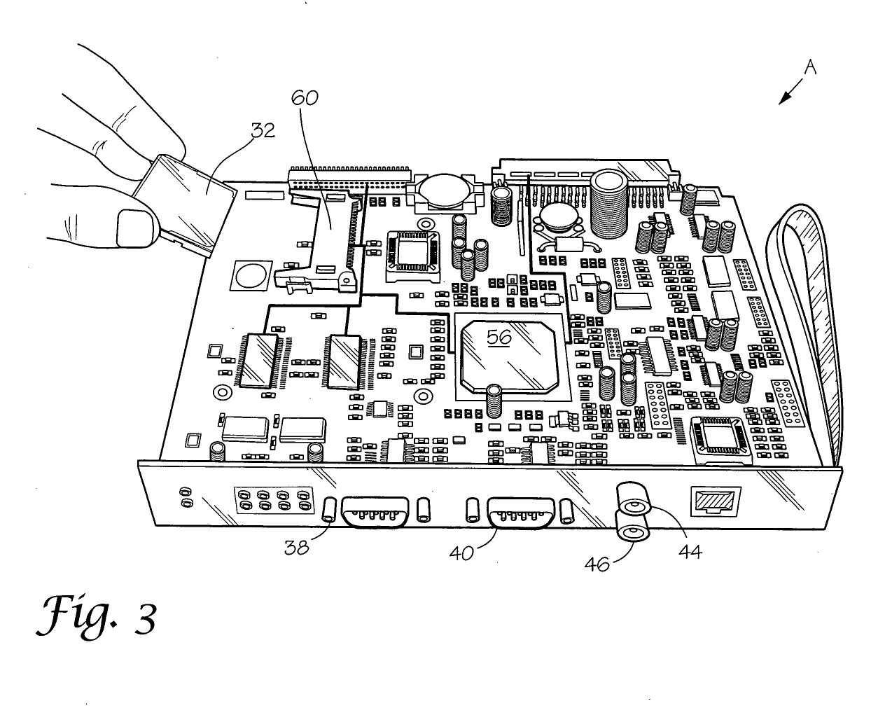

Memory 32 is preferably removable from card A as indicated in FIG. 3 by using memory slot 60. As shown in this preferred embodiment, a user may grasp the sides of memory 32 and pull outward to remove it from card slot 60. This is important because one of the objects of the invention is to provide an easily programmable and upgradeable VM circuit card with integrated audio outputs. If, for example, a user decided to expand the repertoire of MOH and BGM available on card A, the user would first remove the current flash memory 32 and install a new larger capacity flash memory 32. Then the user would connect to card A in one of the manners described above and add one or more new audio files to flash memory 32 for playback, or the music may be prerecorded.

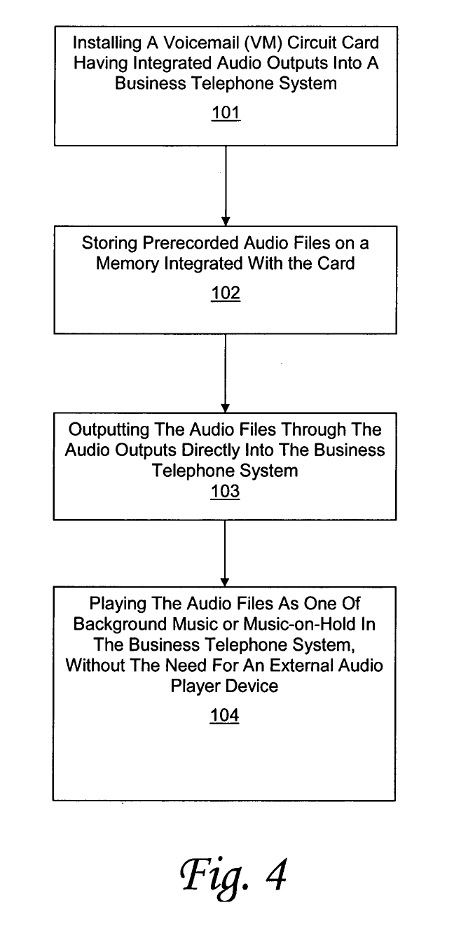

Use of the above illustrated embodiment of the invention is indicated in the flowchart of FIG. 4. In step 101, a user provides a business telephone system VM printed circuit card for use in a business telephone system. In each of the steps of this method, the term user is intended to refer to any party undertaking the step and is not necessarily limited to an end-user, technician, or provider. This is accomplished, for example, by installing card A in a business telephone system as described above with reference to FIG. 1.

One or more prerecorded audio files 33 is stored on integrated memory 32 on the VM card at step 102. Again, with reference to card A of FIGS. 1 and 2, step 102 may be accomplished by using a computer to connect to card A using appropriate hardware and software to communicate with card A. Once connected, the user may electronically transfer and save one or more audio files 33 on flash memory 32. Alternately, the files may be installed on the card before installation.

Once audio files are provided on the VM card, at step 103 an audio output 44, 46 disposed on the VM card is connected to an audio input in the business telephone system in order to playback stored audio files from the VM card in the business telephone system.

In step 104, one or more prerecorded audio files on the memory are output directly to the business telephone system in order to play BGM or MOH directly from the VM card, without the need for an external audio player device.

This method provides for elimination of prior art playback means from the business telephone system and, more importantly, from the business telephone system cabinet, thereby preserving needed space within the cabinet. The method further provides greater flexibility and user-programmability of the VM system and business telephone system overall by allowing for digital storage, playback, and configuration of audio files.

The operation of the aspects of the invention described with reference to software or firmware according to the invention, may be implemented by a set of computer readable instructions or code. Actual computer or executable code or computer readable code may not be contained within one file or one storage medium but may span several computers or storage mediums. The term processor may be hardware, software, or combination of hardware and software that provides the functionality described herein.

Having been taught the aspects of the invention as disclosed herein, the provision of suitable software and firmware is well within the purview of one ordinarily skilled in the field of computer programming. The computer readable instructions may be loaded onto a general purpose computer, special purpose computer, and/or other programmable data processor to produce a machine such that the instructions will execute to create a means for implementing the functions described above.

Physical connection requires plugging an appropriate device, such as a laptop computer running the appropriate software application, into one of the communication ports on the faceplate of the card. Network connection could be accomplished by communicating with the card through the business telephone system's connection to a computer network, wherein a networked computer running an appropriate software application could store and erase files contained on the card's flash memory. These benefits of the present invention allow for greater flexibility in the setup and operation of both the VM system and the business telephone system.

These illustrated examples are offered by way of illustration of the invention's versatility and not meant to limit the invention in any way. The present invention may be embodied in other specific forms without departing from its spirit of essential characteristics. The described embodiments are to be considered in all respects only illustrative and not restrictive. The scope of the invention is, therefore, indicated by the appended claims, rather than by the foregoing description. All changes which come within the meaning and range of equivalency of the claims are to be embraced within their scope.

1. A voicemail circuit card with an integrated audio output for use in a business telephone system having a base unit with a central processor unit and a card slot for receiving and connecting said voicemail circuit card in said base unit, said voicemail circuit card comprising:
a card processor for controlling the flow of electronic data within said card,
a computer-readable memory in communication with said card processor for storing audio files and voicemail message files;
a card connector for electrically connecting said circuit card in the telephone base unit; and
one or more integrated audio outputs built into said card for providing audio output of said audio files stored in said memory;
whereby said voicemail circuit card provides playback of said audio files in the business telephone system through said one or more audio outputs without the need for input from an external audio player.

2. The card of claim 1 wherein said audio files include audio music files stored in said computer-readable memory.

3. The card of claim 2 including a memory card slot, and said computer-readable memory includes a removable flash memory card carried in said card slot.

4. The card of claim 1 including a card faceplate on which said audio outputs are carried.

5. The card of claim 4 including a serial port carried by said card faceplate to provide one of an integration link, programming connection, electronic pager connection, and troubleshooting connection to said card.

6. The card of claim 4 including a plurality of voicemail circuit activity indicators carried by said faceplate to indicate usage of a plurality of voicemail circuits

7. The card of claim 6 further comprising a flash memory status indicator to indicate usage of said flash memory carried by said faceplate.

8. The card of claim 4 further comprising a 10BaseT port carried by said card faceplate for connecting said card to an electronic device using Internet protocol for communication.

9. A business telephone system having a base unit with a central processing unit (CPU), voicemail (VM) capabilities, and a digital interface for communicating with a plurality of handsets, said system comprising:
a VM circuit card installed in a card slot of said base unit;
a card processor for controlling the flow of electronic data within said card,
a computer readable memory resident upon said card in communication with said processor for storing a plurality of audio files;
a card connector for electrically connecting said VM circuit card to said base unit,
one or more integrated audio outputs built into said VM card in communication with said card processor for the output and playing of said audio files in the business telephone system,
whereby said circuit card provides audio playback in a business telephone system from said one or more audio outputs without the need for an external player device.

10. The system of claim 9 including a card faceplate carried by the circuit card exposed upon the exterior of said base unit, and said audio outputs are carried on said faceplate.

11. The system of claim 10 wherein said CPU includes one or more audio inputs, and said one or more audio outputs of said VM card are electrically connected to said one more audio inputs of said CPU.

12. The system of claim 11 including first and second audio outputs for said VM card and first and second audio inputs for said CPU, said audio files including background music (BGM) files and music-on-hold (MOH) files, and said first audio output outputting BGM files to said first audio input and said second audio output outputting MOH files to said second audio input.

13. The system of claim 10 including a serial port carried by said faceplate to provide one of an integration link, programming connection, electronic pager connection, and troubleshooting connection to said card.

14. The system of claim 10 including a plurality of voicemail circuit activity indicators carried by said faceplate to indicate usage of a plurality of voicemail circuits.

15. The system of claim 10 including a 10BaseT port carried by said faceplate to connect said card to another electronic device using Internet protocol for communication.

16. The system of claim 9 wherein said computer-readable memory includes a flash memory card, and said audio files include music files and voice message files for playback.

17. The system of claim 16 wherein said memory card is removable from said audio circuit card.

18. The system of claim 9 wherein said one or more audio outputs are user-programmable to provide audio playback output of selected audio files from among said audio files stored in said flash memory.

19. A method of providing audio playback output of music-on-hold and background music in a business telephone system having a base unit with a central processor comprising:
providing a printed circuit card designed for use as a voicemail card in the base unit of a business telephone system having at least one integrated audio output built into the card;
providing prerecorded audio files stored on a computer readable memory resident upon said card; and
outputting said audio files through said audio output directly from said memory to said central processor of said base unit for playback through said business telephone system.

20. The method of claim 18 using an integrated serial port to connect said VM card to one of an integration link, programming connection, electronic pager connection, and troubleshooting connection.

21. The method of claim 18 further comprising the step of providing one or more voicemail circuit activity indicators to indicate usage of one or more voicemail circuits within said card.

22. The method of claim 18 including the step of using a 10BaseT port to connect said card to another electronic device using Internet-protocol for communication.

23. The method of claim 18 including storing said audio files and VM message files on computer-readable memory.

24. The method of claim 18 including using a removable flash memory to store said audio files.
